(19) United States
(12) Patent Application Publication
(10) Pub. No.: US 2018/0052919 A1
(43) Pub. Date: Feb. 22, 2018

(54) SYSTEMS AND METHODS FOR CONVERSION ANALYTICS

(71) Applicant: Robert M. Feldman, Canton, MA (US)

(72) Inventor: Robert M. Feldman, Canton, MA (US)

(73) Assignee: Xinteractive Inc., Canton, MA (US)

(21) Appl. No.: 15/631,813

(22) Filed: Jun. 23, 2017

Related U.S. Application Data
(60) Provisional application No. 62/420,247, filed on Nov. 10, 2016.
(60) Provisional application No. 62/377,973, filed on Aug. 22, 2016.

(51) Int. Cl. G06F 17/30

(52) U.S. Cl. CPC G06F 17/30719; G06F 7/08; G06F 17/30867

(57) ABSTRACT

Tools are provided for collecting and distributing information from guidance counselors, parents, students, schools, and other third parties regarding the college search and application process. Data points are collected through interaction with computer applications and used to match schools and applicants, provide personalized tours, and predict conversion probabilities allowing colleges and students to tailor their application and admissions processes more narrowly than previously possible.

### CROSS-REFERENCE TO RELATED APPLICATIONS

This application claims priority to U.S. Provisional patent application Ser. No. 62/420,247, filed Nov. 10, 2016, and U.S. Provisional patent application Ser. No. 62/377,973, filed Aug. 22, 2016, the contents of each of which are herein incorporated by reference in their entirety.

### FIELD OF THE INVENTION

The present disclosure relates generally to mobile communication management and conversion analytics for potential college applicants, college students, parents, guidance professionals, and colleges.

### BACKGROUND

The college admissions process relies on outdated communications systems such as direct mailers. Colleges and universities have historically only had access to limited information regarding potential applicants, generally limited to test scores (e.g., ACT and SAT) and minimal data entered by students registering for those tests. Schools are not able to specifically target potential students that may be interested in their schools, instead relying solely on general characteristics such as indicated major interest, test scores, and geographic proximity.

Compounding this lack of information is the fact that, in order to ensure they have full enrollment, schools must offer more students than they have space to accept due to fall off between acceptance and actual enrollment. Applicants will typically apply to and be accepted to multiple schools before deciding on one to attend. Miscalculations on the part of colleges can leave them scrambling to fill empty spots from their waitlists or scrambling to defer students or find space for over-enrollment.

From a student's perspective, they currently have to track down information on schools in magazines, at separate websites for each school or in person at regional fairs. Colleges are generally unable to track these interactions to identify specific interests of students or to assess the likelihood that a student may apply to or enroll at a given school. Furthermore without dependable guidance on their likelihood of admission to a given school, students generally must apply to a large number of schools due to selectivity and uncertainty regarding their acceptance.

There currently exists no means for compiling, sorting, and analyzing data in the college search process, either from the perspective of the student searching for a school or from the perspective of a school searching for applicants.

### SUMMARY

The present invention provides a platform for managing and tracking engagement in the college application process and beyond for parties such as potential and enrolled students, parents, guidance counselors, colleges and universities, and affiliated companies that market to college students. Methods of the invention may include providing a central college search gateway which may be a computer program or mobile application that requires an account or other means of identifying a user and tracking their interactions. Specific schools may create and alter their own profiles on the application which may, in turn, link to independent web pages or other information from the school. Because traffic to the school sites is originated within the application, the student's interaction therewith can be monitored and tracked. This is in contrast to existing systems where a student's direct visit to, for example, a college's web site, would likely not be monitored or tracked by the school.

By providing a centralized, mobile application for the college search process, systems and methods of the invention can conveniently streamline the college search process are useful in monitoring and tracking actions taken by potential students and associating that data with specific students. Methods of the invention may use this data to identify schools that the student may be interested in and to predict a likelihood that the student will take a certain action such as apply, be accepted, place a deposit, enroll, be retained past their freshman year, graduate, and find a job. Furthermore, the invention may use student data to identify colleges that best suit the student's criteria or may provide student-specific information regarding likelihood of success at a specific school (e.g., acceptance, graduation, and earning potential). Schools may have individual spaces within the platform that may be customizable with respect to layout, background and general branding to reflect the desired appearance of the school. As noted elsewhere, these spaces may contain links to various websites and/or information external to the application/platform. In certain embodiments, the links may be dynamic such that they are automatically changed depending on the student visiting the page or space and the data associated with the student. For example, links may change based on a major interest indicated by the data or based on a prediction of a student's likelihood to apply or take another step in the application process (e.g., when likelihood that a particular student will enroll, as calculated from the collected data, exceeds a certain threshold, financial aid or housing links begin to appear on that school's page when the student visits).

Prospective students or applicants may be organized or sorted based on data obtained in the application and schools, advertisers, counselors, or other parties may send messages or event invitations to groups based on shared characteristics. In certain embodiments, students may opt into messages from certain schools, or groups of schools or opt to receive messages and/or offers from retailers or banks regarding financial aid.

Systems and methods of the invention may provide interactive campus tours in either virtual reality or augmented reality. Such tours along with other information provided to the student may be curated based on the data gathered through interaction with the application. For example, systems of the invention may have collected data indicating a student is interested in engineering or athletics and may tailor a tour or campus information to focus on athletics facilities or the school of engineering.

Systems and methods of the invention may also provide a links to college applications or serve as a central database for essays, resumes, and/or other application materials. In certain embodiments, methods of the invention may include auto-populating applications or other forms with information from the student's profile. Systems and methods of the invention may include providing links to application services such as financial aid planners, tutors, or general college guidance. In addition to providing links to external web sites for particular schools (wherein the links may be customizable by the school), applications may provide links or targeted advertisements or offers to select retailers based on the data collected with respect to the student such as geographical location of potential colleges, etc. In certain embodiments, collected student data may be used to generate leads for schools (e.g., students that are interested in a particular school or type of school), or other companies such as movers, storage companies, or retailers dealing in dorm materials or electronics. These leads may be provided to select companies or schools based on a subscription or per lead basis.

In various embodiments, collected data may trigger a certain response such as sending a message from a potential school of interest to a student within the application. Other responses may include legacy modes of communication such as mailing information or application materials to a student, sending an email or text message to the student, or placing a telephone call to the student. In application communications may also be triggered by legacy inputs. For example, systems and methods of the invention may integrate with a school's customer relation management systems (CRM) such that receipt of an e-mail or external communication from a student is recorded in databases of the invention and may trigger in application messaging or invitations to explore application functionality described herein such as the campus tour features. Tracked legacy interactions may include, for example, receipt of an inquiry form, request for materials, inbound call, inbound email, attendance at an event, campus visit, interview, college fair attendance, admissions representative interaction, financial aid application, college application, admission, wait listing, deposit receipt, enrollment, or class registration.

In certain aspects, systems and methods of the invention may include predicting a likelihood of conversion for a certain school and student. Conversion may include, for example, applying, placing a deposit, enrolling, continuing on to second, third, or fourth year, graduating, gaining employment in the student's field, lifetime earning potential, future alumni giving contribution by the student, etc. Likelihood of conversion may be based on one or more of the following data points collected for a student within the platform: College appears in a student's search results; Student opens a message from the college; Student clicks upon a message from the school; Student participates in or completes an interactive message or application relating to the school (e.g., question and answer session); Student uses their platform profile to register for an event, a campus tour (real or virtual), financial aid, and/or begin or complete a college application; Student visits a college featured profile; Student clicks on any number of links, videos, maps, or other features clicked or viewed by the user (e.g., likelihood of conversion may increase based on the number of clicks or the time spent viewing any given feature); Student adds college to a favorite list or saves or bookmarks college space within platform; Student visits specific college social media channels; Student searches or sorts search results by specific criteria, such as distance from home, student population, or tuition; Student saves certain search filters for future use; Student shares information relating to a school on social media or with a friend; or Student opts in or out from various types of communications from a college. In certain embodiments, likelihood of conversion may be determined based on the number of data points, what the data points are, and/or the order of the data points.

The present invention provides capability unmatched by current recruitment methods, allowing schools to more accurately model and predict application, enrollment, and graduation rates and providing tools to better identify and communicate with potential applicants. Systems and methods of the invention also provide students with a centralized platform to conduct a college search along with a host of tools for identifying potential colleges, majors, financial aid options, and more.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram illustrating one embodiment of an exemplary method of the invention.

FIG. 2 shows a screenshot of a user interface provided by the platform for a user profile.

FIG. 3 shows screenshots of a user interface provided by the platform for a specific college having certain features of the invention.

FIG. 4 shows a screenshot of a user interface provided by the platform for a featured college.

FIGS. 5 and 6 show screenshots of a user interface provided by the platform for map-based college searching.

FIG. 7 shows screenshots of a user interface provided by the platform for notifications and messaging.

FIG. 8 shows screenshots of a user interface provided by the platform for college search functionality.

FIG. 9 shows a screenshot of a user interface provided by the platform for creating a profile or inputting college search criteria.

FIG. 10 shows screenshots of user interfaces provided by the platform for communications and social networking applications.

FIG. 11 shows a screenshot of a user interface provided by the platform for launching campus tour applications.

FIG. 12 shows a screenshot of a user interface provided by the platform for interacting with printed materials from colleges.

FIG. 13 shows screenshots of several branded user interface pages on a mobile device.

FIG. 14 shows screenshots of a user interface provided by the platform for guidance counselor interaction.

FIG. 15 shows screenshots of a user interface provided by the platform offering general college application links, features, and advice.

FIG. 16 shows screenshots of a user interface provided by the platform illustrating notifications from colleges.

FIG. 17 gives a more detailed schematic of components that may appear within a system of the invention.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

Systems and methods of the invention provide a centralized management platform for the college search process, bringing together schools, potential students, parents, guidance counselors and other parties in one application and leveraging the obtained data to inform advertising and the application and admission processes as well as to curate the search process by tailoring information, messages, and interactive features to individual students.

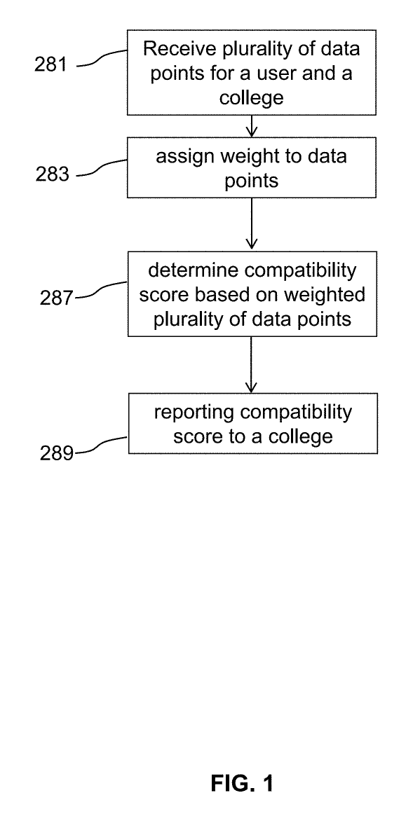

FIG. 1 provides a block diagram illustrating one embodiment of an exemplary method of the invention. A computer device (e.g., a server) receives a plurality of data points from a user and/or a college 281. The data points may include, for example, college search result; opened message; clicked on message; interactive program begun; interactive program completed; registration for event; application submission; college profile views; college profile interaction; college profile added to favorites; college search filters; user profile; and communication subscriptions.

The college search result data point may be a binary point indicating whether a user did or did not receive the college as a search result in response to a search run using methods of the invention. The opened message data point may be a binary indicator of whether or not the user has opened a message in the system received from the specific college or may be a numerical indicator relating to the number of messages opened. The clicked on message data point may relate to if a user has licked on a message from a college or how many messages the user has clicked on. In various embodiments viewing messages, links or features may be scored based on whether the user viewed the item, how long the user viewed the item, the number of items viewed, how the user interacted with the item (e.g., clicks in an interactive feature), or the number of times an item was viewed. The interactive program begun data point may relate to whether an interactive feature, such as a quiz on the application was started. This data point may further reflect how long the user interacted and the level of engagement as represented by number of clicks or other measures. The interactive program completed data point may reflect completion of an interactive feature, such as a quiz or survey. The registration for an event data point may reflect whether the user has registered for or attended an event (e.g., a campus tour, a college fair, or a local gathering) and may further reflect how many events and be weighted based on the type of event (e.g., an in-person campus visit weighted higher than an information session at a college fair). The application submission data point may reflect whether the user has submitted an application to the college and/or whether the user has submitted applications to other colleges as well as the type of application (e.g., an early decision application is weighted higher than a general but college specific application which is weighted higher than a universal application). The college profile views data point may account for views of the colleges profile within the application. The college profile interaction data point may reflect the level of interaction with the profile as described above (e.g., moving past the first page or clicking links within the profile page). The college profile added to favorites data point may relate to whether the user has added the college to a watch list or otherwise saved or favorited the college or the college's profile page. The college search filters data point can reflect the criteria a user has used or saved in a college search and may be weighted based on how those criteria compare with the statistics or features of the specific college. The user profile data point includes any information entered by the user such as grade point average (GPA), test scores, geographic location, or major interest and may be scored based on data analysis of other similar users and schools they applied to or attended. Communication subscriptions may reflect a user opting into or out of notifications, emails, mailing lists, in-application messaging, or telephone and text messaging lists for a college.

Systems and methods of the invention may include profile pages, micro-sites, and other features to provide an in-application presence for colleges, commercial organizations (third party retailers and other companies), high schools, or other organizations. Features discussed in more detail below with respect to colleges may also be applied to these organizations. For example, systems and methods may provide tools for high schools to manage their own communities.

The data points may be weighted 282 based on measured past influence on other user's college decisions or other criteria. A compatibility score for the user and one or more colleges may then be determined 287 based on the available weighted data points. The compatibility score may then be reported 289 to the college, financial aid institutions, or various retailers as advertising leads. In certain embodiments, a compatibility score above a certain threshold may automatically generate an action such as a branded or other in application message, a telephone call, a text message, an email, paper mail, or personalized offers for goods or services. Generated leads may be given to schools or other parties as part of a subscription service or on a per-lead basis. In certain embodiments, leads may be weighted based on likelihood of success wherein stronger leads more likely to convert to enrolled students or applicants may demand higher compensation from interested colleges or third parties.

Reporting the compatibility score may comprise creating a written report and transmitting the written report to the college. The written report may be a computer generated chart or other document which may be transmitted electronically via text message or email or may be printed using a printer input/output device and physically transmitted to the end recipient.

The compatibility score may be reported to a user or used to determine a list of colleges to report to the user based on exceeding a compatibility score threshold. In certain embodiments, users or colleges or other third parties may be able to select or change the threshold in order to increase or decrease the number of users or colleges returned.

In certain embodiments, the compatibility score may reflect the order in which data points are accrued such as an application submission after a college visit is weighted higher than a college visit after an application submission.

In certain embodiments, systems and methods of the invention may relate to determining a probability of a specific college converting a user based on the user's compatibility score with that college. Conversion may include the user scheduling a visit, submitting an application, being accepted, placing a deposit, enrolling, registering for classes, continuing at the school after any given year, graduating, finding a job in their field of study or otherwise, contributing as an alumni donor, or taking other actions.

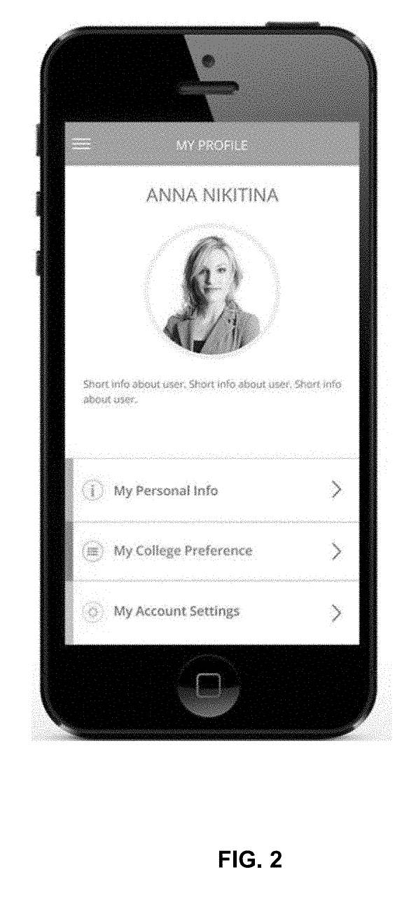

FIG. 2 shows a screenshot of a user interface provided by the platform for a user profile. The user may sign up as a parent, high school student, guidance counselor, GED earner, adult learner, college graduate, or other. The user may enter, using an input device, information for their personal profile including first name, last name, year of high school graduation, name of high school, city, state, zip, and country. User profiles may be organized and viewable by any of several factors such as high school, state, GPA, major interests, test scores, or others. Students may share information about themselves, including areas of interest, academic and personal accomplishments, and may demonstrate interest in colleges by, for example, adding them to a “Favorites” list. Students may upload video, images, and web pages to their profile.

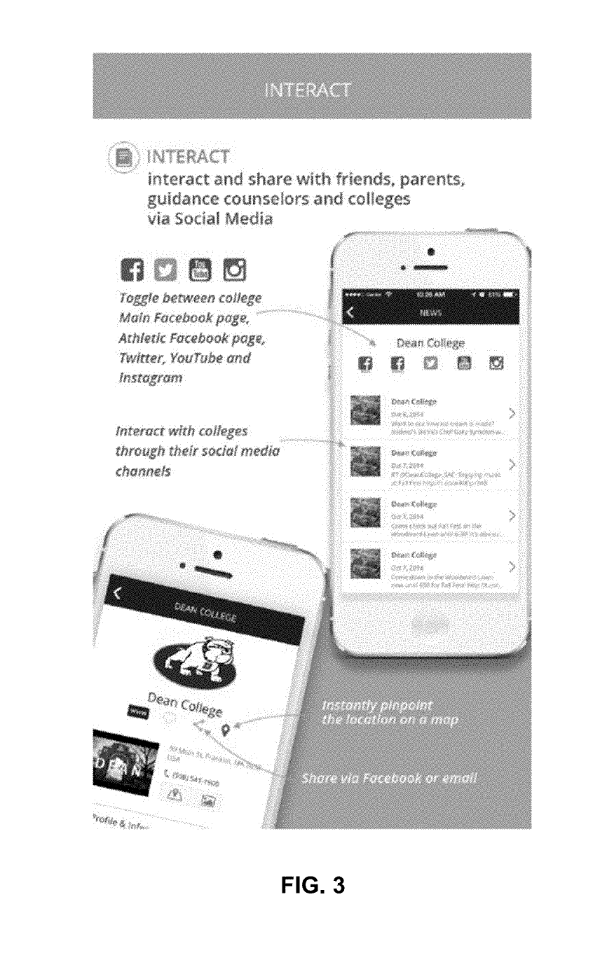

FIG. 3 shows screenshots of a user interface provided by the platform for a specific college having certain features of the invention. Users may interact with the college's profile page to, for example, toggle between social media accounts and messages from the school, interact with the school through the various social media channels, locate the school on a displayed map with directions, or share the schools profile with other individuals through messaging or social media platforms.

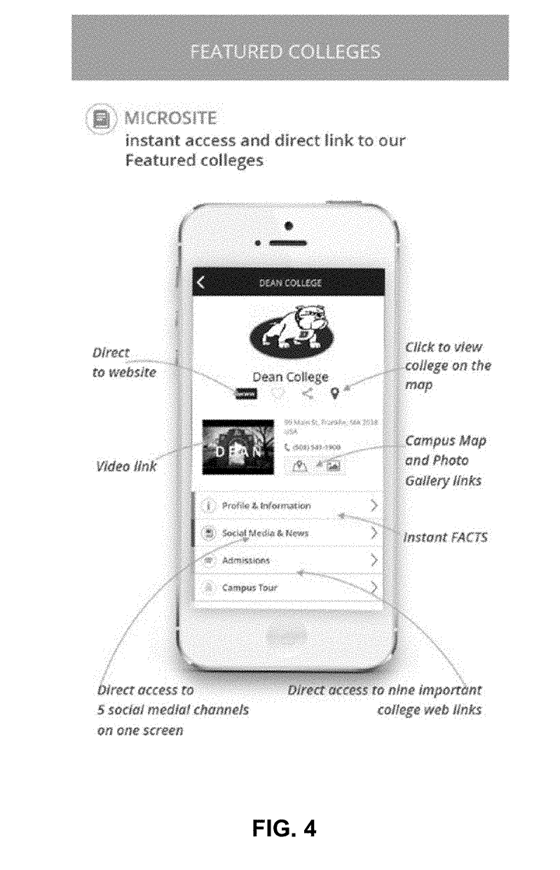

FIG. 4 shows a screenshot of a user interface provided by the platform for a featured college. The user may link to the school's website or various pages therein (e.g., athletics or major specific pages), may view a gallery of images or videos about the school, may view information about the school such as admission statistics or majors offered, or schedule a campus tour or view a virtual tour. In certain embodiments, links within a mobile application of the invention, for example, links on a school's profile page(s), may direct a browser on the user's computer to open the linked web-page. In certain embodiments, links may direct an in-application browser to open the linked web-page or content such that user interaction with the content (e.g., time spend viewing, scrolling, additional clicking within the content, or number of pages visited) can be tracked by the application and associated with the specific user for use in determining compatibility scores and in other aspects of the invention. The in-application browser linking may also apply to third party retailers, high schools, financial aid providers, or other parties with linked content within the mobile application.

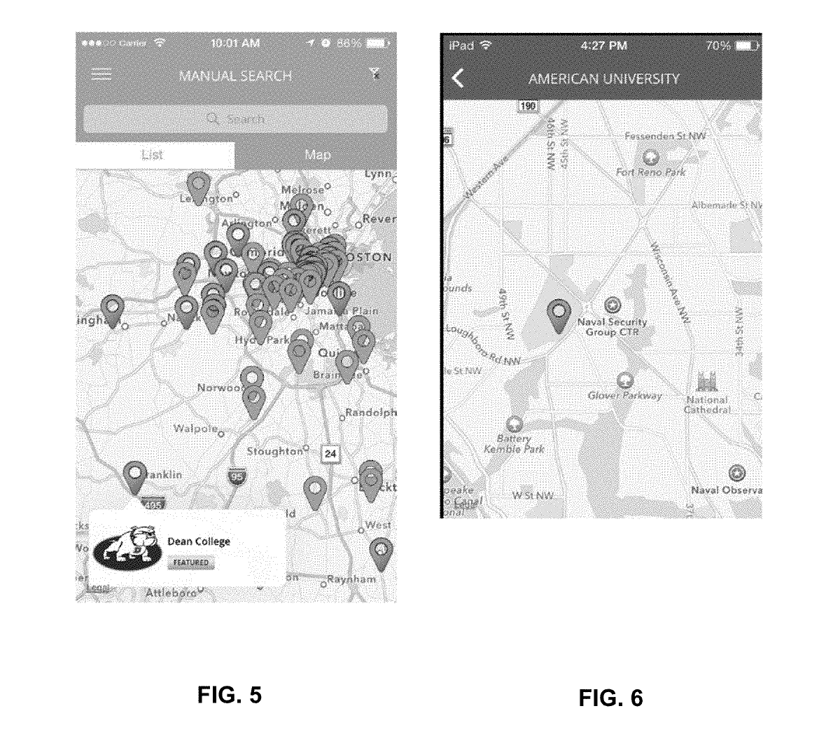

FIGS. 5 and 6 show screenshots of a user interface provided by the platform for map-based college searching. College search features of the application, including providing a list of colleges matching a user's input criteria, may include showing results on a map as indicated in FIG. 5. Featured colleges or colleges matching other criteria may be indicated by different markers (e.g., different colors or shapes). Maps may be zoomed in or out or moved to expand or contract the number of returned hits. A college's profile may link to a map of the school's location as shown in FIG. 6.

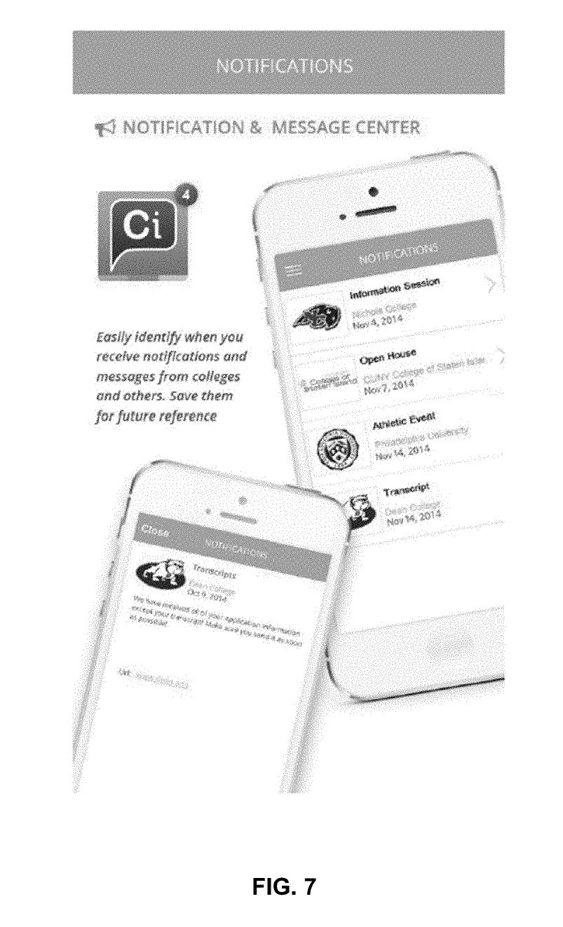

FIG. 7 shows screenshots of a user interface provided by the platform for notifications and messaging. The application may provide a list of in-application messages received from all parties. The display may also include out-of-application emails, text messages, calls, or other forms of communication. Communications may be sortable based on sender, compatibility score, or other criteria. Notifications may also include deadline reminders or event invitations and may be auto-generated by the application.

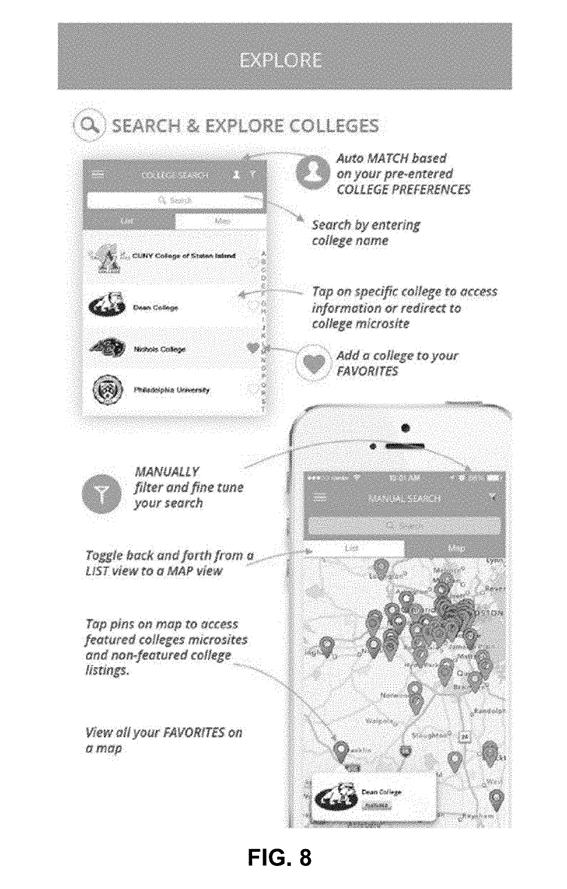

FIG. 8 shows screenshots of a user interface provided by the platform for college search functionality. College searches may be auto matched based a user's profile or compatibility score as discussed above or may be conducted based on entered criteria on a per-search basis. Clicking on a returned result may direct the user to the school's profile page, micro-site, or other school specific location. Results may also be sorted, viewed, and explored using a map display.

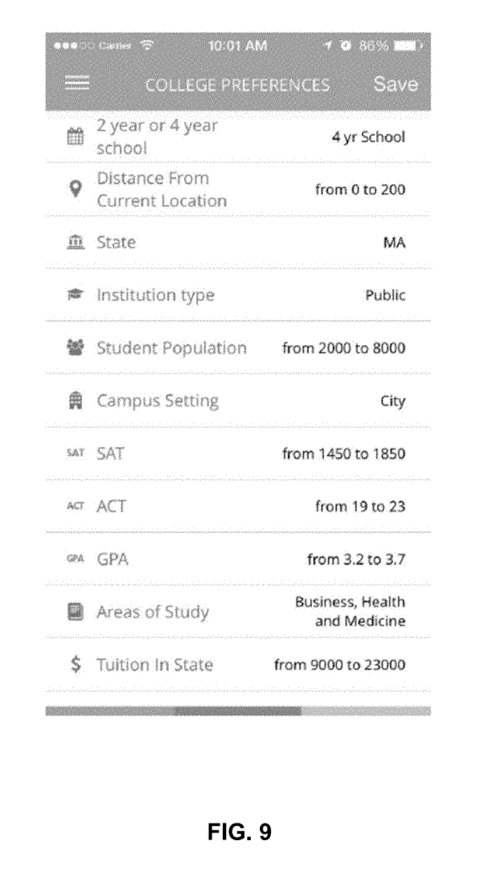

FIG. 9 shows a screenshot of a user interface provided by the platform for creating a profile or inputting college search criteria. Within a college search field or as part of a user profile creation, users may enter college preferences such as 2 year or 4 year school, distance from a specific location, state, institution type (e.g., public or private), campus setting (e.g., rural, urban, or suburban), student population, majors offered, student to teacher ratio, average test scores, average GPA, predicted earnings for graduates, graduation percentage, freshman retention rates, tuition, financial aid packages, athletic or extracurricular offerings, research, group affiliation, religious affiliation, fellowship recipients, and others.

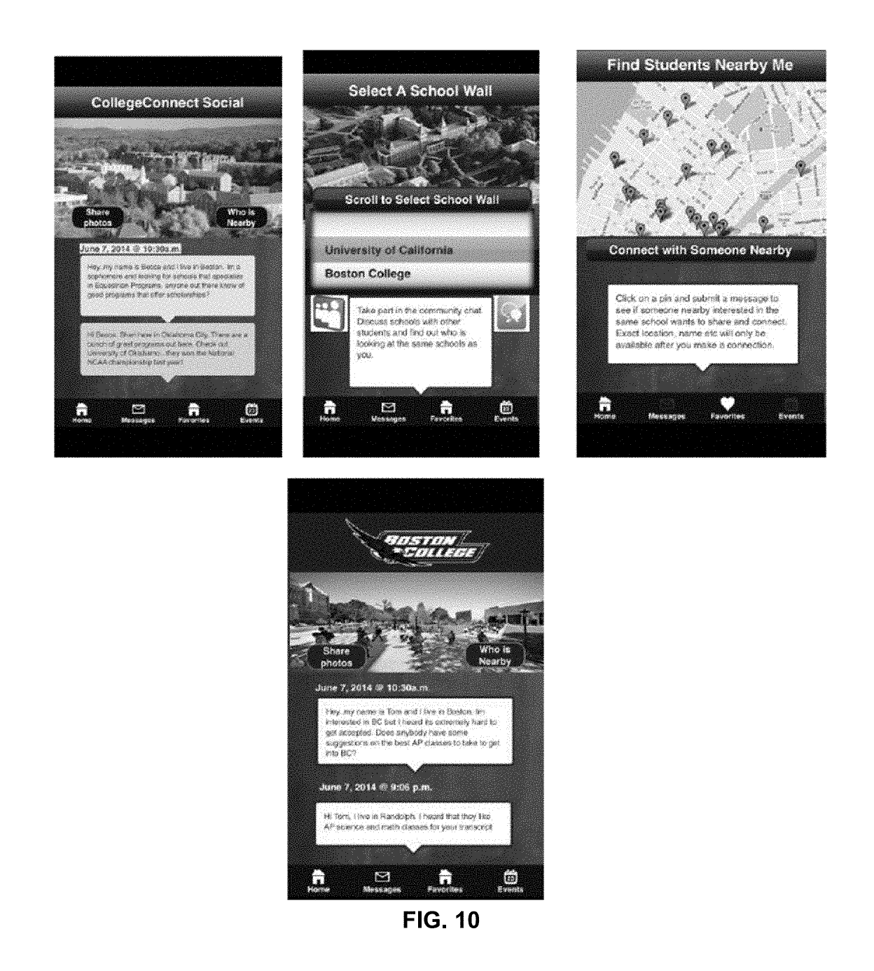

FIG. 10 shows screenshots of user interfaces provided by the platform for communications and social networking applications. Communication capabilities may include messaging applications among users, between users and schools, guidance counselor's or other third parties, posting on a school's page, location based identification of other users of third parties, and sharing of media such as videos, images, and audio.

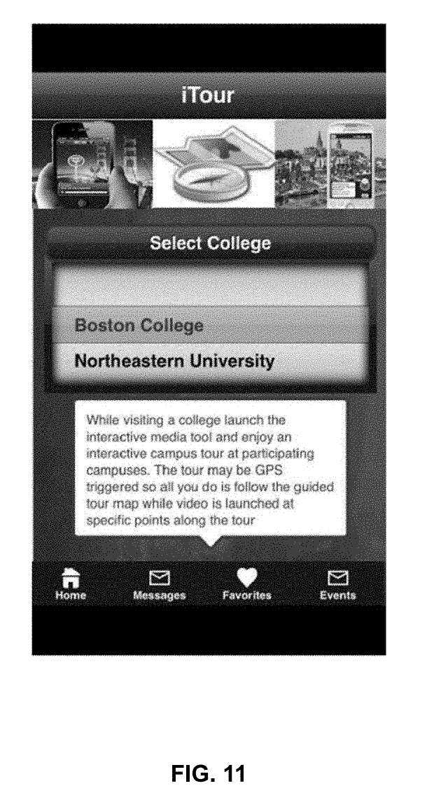

FIG. 11 shows a screenshot of a user interface provided by the platform for launching campus tour applications. In certain aspects, systems of the invention may provide interactive college tours. Systems may include a computer comprising a non-transient, tangible memory coupled to a processor, a location device, and a display device. The computer, which may be a mobile device, can be configured to identify a location of a user using the location device and display, on the display device, curated content regarding a college based on the location of the user. Alternatively, a user may view curated content through a link from a school's profile page or through a dedicated tour page such as shown in FIG. 11 wherein the user may select tours from a list of schools. Tours may be entirely virtual through standard video or through an interactive display such as a 3d headset where user input determines the displayed images. Campus tours may also be in person with augmented features available through the application. For example, augmented reality displays such as google glass or mobile device displays may overlay virtual components such as building labels, over real images captured live by a device's camera during a physical tour. Augmented reality features may use the device's GPS, Wi-Fi, or other location services to trigger supplemental content such as text, images, video, or audio relating to a particular building or location. In certain embodiments, the information provided in the virtual or augmented tour may be curated based on calculated interests from data collected during the user's interaction with the application. Such data may include any of the data points discussed above. For example, an augmented reality tour may guide a user to the school of engineering where that user has indicated an interest in an engineering major and may avoid the school of humanities or may provide information on athletics if data points indicate the user is likely to be interested in sports.

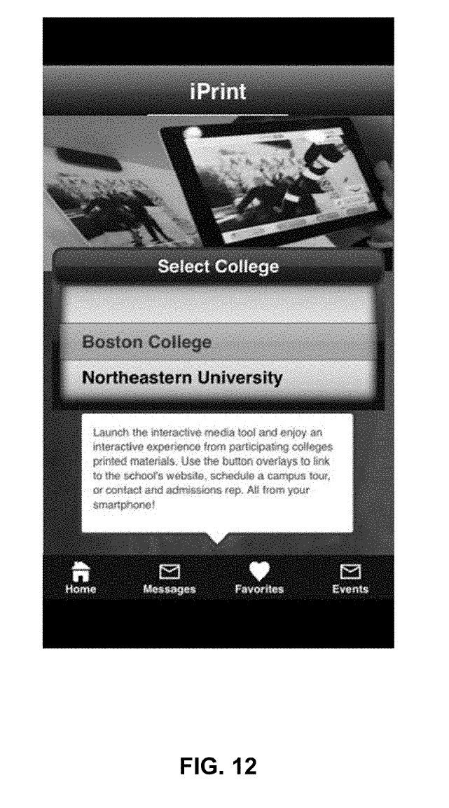

FIG. 12 shows a screenshot of a user interface provided by the platform for interacting with printed materials from colleges. Similar to campus tours, printed material may also be viewed, requested, or printed from links on a school's profile pages or through a dedicated printing page as shown in FIG. 12 where printed materials may be browsed based on the selected college.

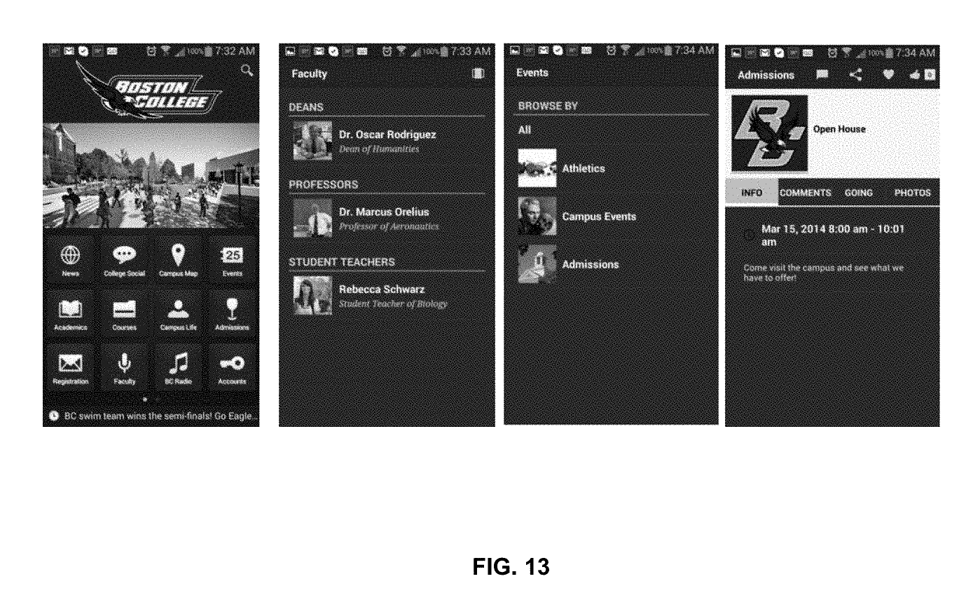

FIG. 13 shows screenshots of several branded user interface pages on a mobile device. Individual colleges may have their own profile pages that may be managed by the school, through the application. Presence on the application may be through a fee-associated membership and may be tiered such that there are different levels of membership that provide, among other things, different levels of profile pages. For example a basic membership may include a generic portal with the school's name and basic information and a limited number of links while a premium page may appear as the profile shown in FIG. 13 with school images and colors branding each page and images associated with a greater number of links. Pages within a profile may include, for example, a front page, a directory, events listing, messaging or notifications page, and may include a news ticker. Links may include news, social networking feeds, maps, academic profiles and information, campus life, course listings, admissions department links, information or registration forms, various messaging pages, and audio, video, and image galleries. In certain embodiments, the links displayed may be curated similarly to the campus tour information based on user preferences either indicated or inferred through data points.

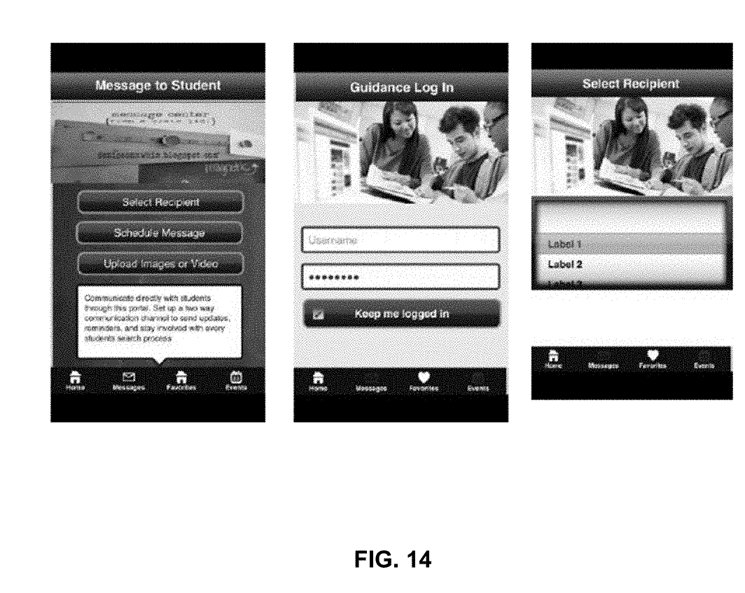

FIG. 14 shows screenshots of a user interface provided by the platform for guidance counselor interaction. Systems and methods of the invention may provide guidance counselor specific tools such as messaging and notifications which may be sent to entire groups defined based on various criteria. For example, the application may keep records on users that have submitted applications and allow a guidance counselor to send deadline reminders only to student users who have not yet submitted applications.

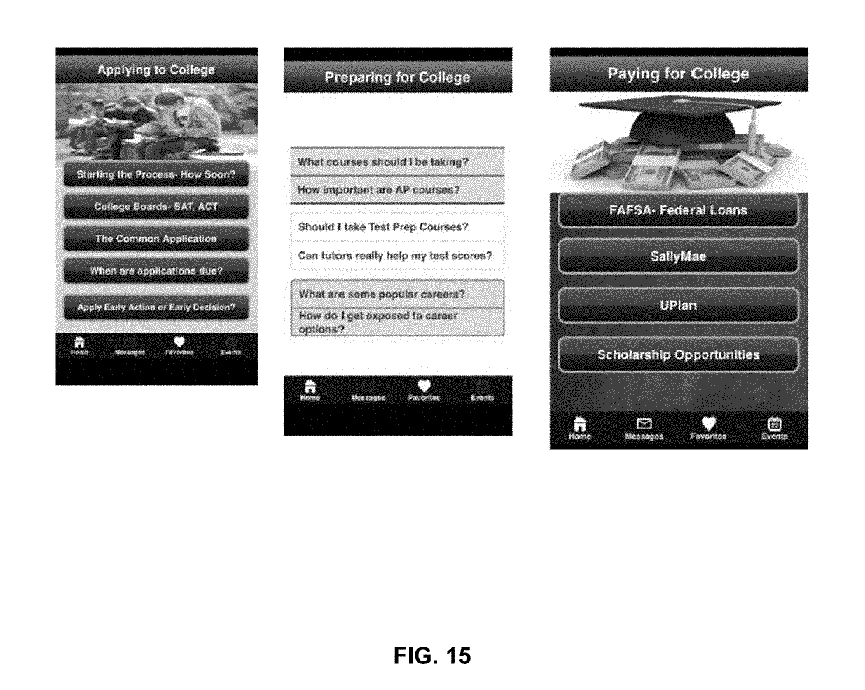

FIG. 15 shows screenshots of a user interface provided by the platform offering general college application links, features, and advice. Systems and methods of the invention may also provide general information on college applications, admissions, testing, and financing, among other items. General information may be provided in the form of surveys or quizzes designed to elicit information from a user. This information may, in turn, form data points for use in determining compatibility scores or curating information to be presented later.

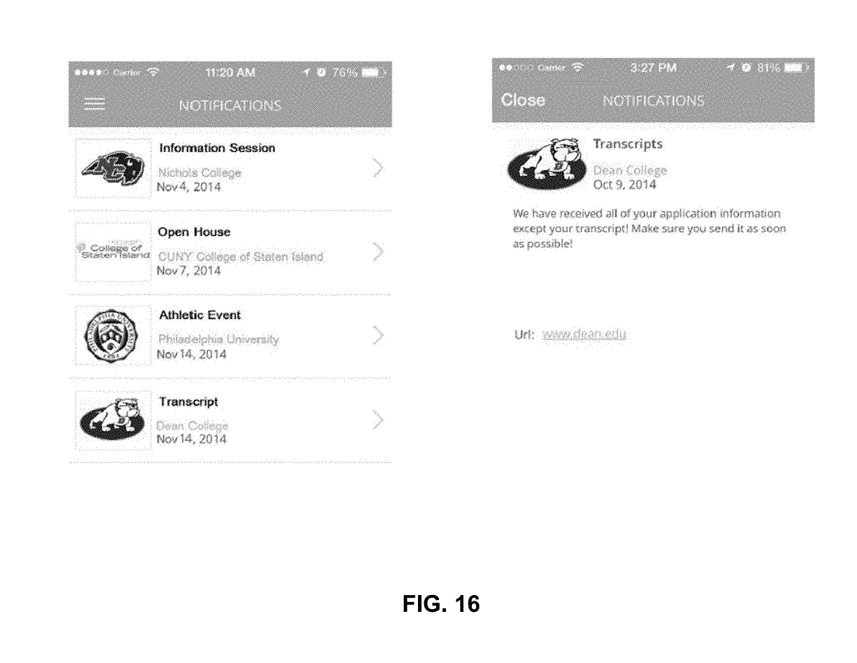

FIG. 16 shows screenshots of a user interface provided by the platform illustrating notifications from colleges. In various embodiments, colleges may customize their presence on programs or applications of the invention in order to display certain information or reflect college specific branding. A portal may be provided wherein a college can enter general information in response to targeted queries. Examples of profile information include name, listing type, website and information links, phone numbers, address, GPS coordinates, housing options, college type, education period (e.g., 2 year or 4 year), campus type, faculty to student ratio, and total enrollment. High schools and other organizations as discussed herein may also maintain a presence on programs and applications of the invention with branded content as described above.

Within a micro-site, for example, a high school may customize their content and provide links for students. College admission representatives may directly connect with specific students through the application as well and view student profiles for a particular high school. Colleges, third party retailers and other commercial organizations may send messages to a group of students at a particular high-school or a sub-group (e.g., students having a GPA above a certain threshold) or may provide advertisements or place information on a high school's micro-site. The micro-site appearance for a high school may be tailored for each student based, for example, on data points for that student. In-application messaging for high schools and other parties is also provided for such that messaging may be sent to all participating students or some sub-group thereof based on student data points. Similarly, other groups may be messaged or receive, create, manage, or view content within the organization's micro-site (e.g., parents, teachers, administrators).

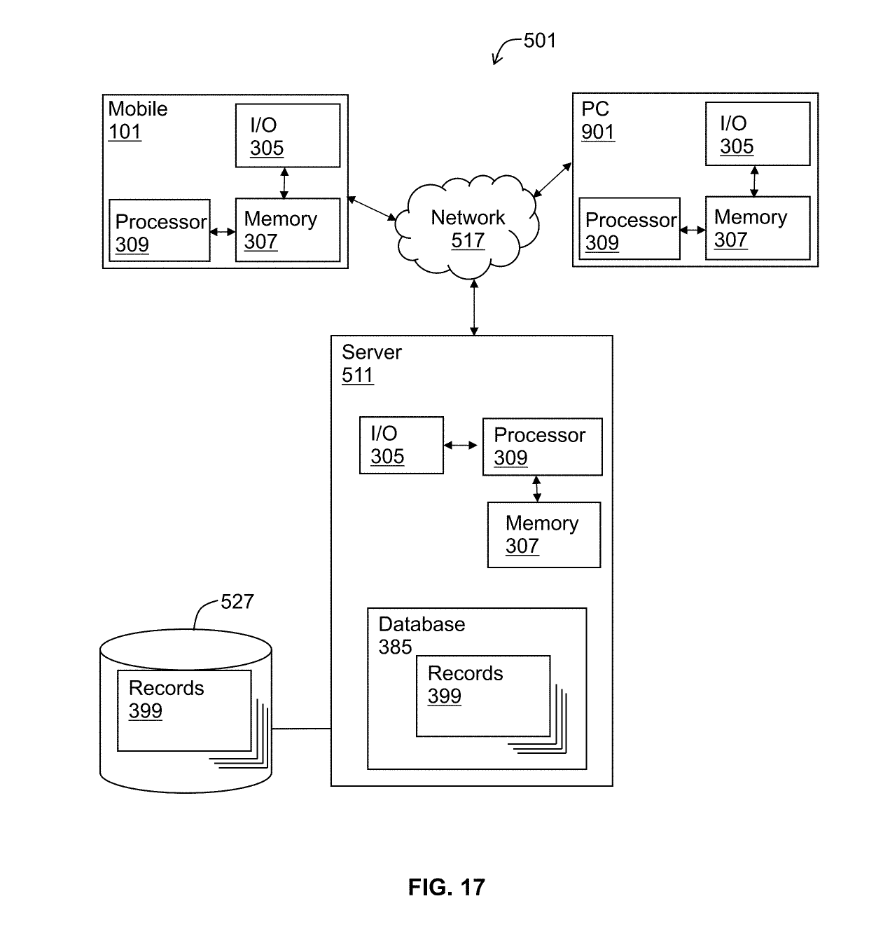

As one skilled in the art would recognize as necessary or best-suited for the systems and methods of the invention, systems and methods of the invention may include computing devices as shown in FIG. 17 that may include one or more of processor 309 (e.g., a central processing unit (CPU), a graphics processing unit (GPU), etc.), computer-readable storage device 307 (e.g., main memory, static memory, etc.), or combinations thereof which communicate with each other via a bus. Computing devices may include mobile devices 101 (e.g., cell phones), personal computers 901, and server computers 511. In various embodiments, computing devices may be configured to communicate with one another via a network 517 in order to display application images or allow remote storage, viewing, or selection of application pages.

A processor 309 may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory 307 preferably includes at least one tangible, non-transitory medium capable of storing: one or more sets of instructions executable to cause the system to perform functions described herein (e.g., software embodying any methodology or function found herein); data; or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage 527 such as, for example, Amazon Web Services, memory 307 of server 511, cloud storage, another server, or other computer-readable storage. Cloud storage may refer to a data storage scheme wherein data is stored in logical pools and the physical storage may span across multiple servers and multiple locations. Storage 527 may be owned and managed by a hosting company. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to allow the operability described herein for various systems and methods of the invention. For example, systems and methods herein can be implemented using Perl, Python, C++, C#, Java, JavaScript, Visual Basic, Ruby on Rails, Groovy and Grails, or any other suitable tool. For a computing device 101, it may be preferred to use native xCode or Android Java.

In certain embodiments, client-server communications may be managed as follows. Methods of the invention may be carried out using computers or mobile devices via programs or applications. Mobile applications may consist of two main parts: a client part (e.g., iOS application) responsible for interaction with students, parents and guidance counselors; and a server part responsible for providing data to the iOS application. Mobile devices, and servers may comprise computers or computing devices as described above. Configuration and data management may be accomplished by administrators using the application. The server application may be deployed, for example, on a dedicated server in Amazon EC2 cloud with 3 open ports (80 for HTTP, 443 for HTTPS protocol and 22 for SSH). Accessing port 80 can automatically redirect user to port 443 so that user interactions are always protected by SSL. This may also prevent XSS attacks. Access to SSH can be limited to a set of IP addresses for application maintenance.

Communication between client and server applications may be based on HTTPS protocol. Accordingly, the body of the message and URLs of all requests may be encrypted. JSON may be used as format for transferring data. The server application may be based on a Java EE platform and use the following technologies: Java Web Applications based on Servlet as basis for the application (Tomcat 7.x can be the web server). Tomcat security settings may follow recommendations from Apache Foundation. Tomcat can be running as a non-root user to prevent security problems; Tomcat Realms may be used for user's authorization and authentication; Java Persistence API may be used for working with databases. NamedQueries can be used for selection data in the database to avoid SQL injection; SHA512 with salt may be used for building password hash and to avoid equal hash for the same passwords; Restlets can be used for providing RESTful web-services; Google Guice may be used for linking all technologies.

Data may be stored in PostgreSQL 9.3, which can be deployed on the same server and may be protected from external calls. Databases of the invention may not be available for external usage with port 5432 being closed by firewall.

As used herein, the word “or” means “and or or”, sometimes seen or referred to as “and/or”, unless indicated otherwise. As used herein, “click”, “clicked” or “clicks” may refer to mouse clicks on a link, keyboard strokes, finger taps on a touchscreen, or any other interactions with a computer device/mobile device through an input/output (I/O) device. The terms, “school”, “college”, and “university” are used herein interchangeably and refer to educational institutions.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Where features herein are described with respect to colleges or schools, it should be understood that the same features may apply to high schools, colleges, universities, companies, and any other organizations.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A computer implemented method of targeting potential applicants, the method comprising:
receiving, at a computer comprising a processor coupled to a tangible, non-transient memory, a plurality of data points from a user for a college obtained by monitoring user interaction with the computer, the plurality of data points comprising two or more selected from the group consisting of: a college search result. an opened message, a clicked on message, an interactive program begun, an interactive program completed, a registration for event, an application submission, college profile views, a college profile interaction, a college profile added to favorites, college search filters, a user profile, and communication subscriptions;
assigning a weight to the plurality of data points;
determining a compatibility score for the user and the college using the weighted plurality of data points^{.} and
calculating a probability of conversion based on the compatibility score, wherein the probability of conversion comprises one selected from the group consisting of a probability of the user requesting more information, registering for an admissions event, attending an admissions event, applying to the school, a probability of the user placing a deposit with the school, and a probability of the user enrolling in classes at the school.

2. The method of claim 1 further comprising providing the compatibility score in a report to the college wherein the compatibility score is greater than a threshold value.

3. The method of claim 2 wherein the report comprises a written report, the method further comprising transmitting the written report to the college.

4. The method of claim 1 further comprising reporting the compatibility score to the user wherein the compatibility score is greater than a threshold value.

5. The method of claim 1 further comprising transmitting application materials to the user based on the compatibility score.

6. The method of claim 1 further comprising transmitting advertising materials based on the compatibility score.

7. The method of claim 1 wherein the compatibility score is based in part on an order of occurrence of the plurality of data points.

8.-9. (canceled)

10. The method of claim 1 further comprising reporting the compatibility score to a third party.

11. The method of claim 10 wherein the third party is a retailer.

12. The method of claim 10 wherein the third party is a financial aid provider.

13. The method of claim 1 further comprising creating a group comprising a plurality of users having one or more common data points.

14. The method of claim 13 further comprising automatically generating and sending a message to the group based on the one or more common data points.

15. The method of claim 1 further comprising modifying the appearance of a college's space displayed to the user based on the plurality of data points and the compatibility score.

16. The method of claim 8 further comprising modifying the appearance of a college's space displayed to the user to include information selected from the group consisting of financial aid, fields of study, and campus housing when the probability of conversion is greater than a threshold value.

17.-18. (canceled)

19. A computer implemented method of targeting potential applicants, the method comprising:
receiving, at a computer comprising a processor coupled to a tangible, non-transient memory, a plurality of data points from a user for a college obtained by monitoring user interaction with the computer, the plurality of data points comprising two or more selected from the group consisting of: a college search result, an opened message, a clicked on message, an interactive program begun, an interactive program completed, a registration for event, an application submission, college profile views, a college profile interaction, a college profile added to favorites, college search filters, a user profile, and communication subscriptions;
assigning a weight to the plurality of data points;
determining a probability of conversion for the user and the college using the weighted plurality of data points, wherein the probability of conversion comprises one selected from the group consisting of a probability of the user requesting more information, registering for an admissions event, attending an admissions event, applying to the school, a probability of the user placing a deposit with the school, and a probability of the user enrolling in classes at the school; and
modifying a page for the college displayed to the user to include information selected from the group consisting of financial aid, fields of study, and campus housing when the probability of conversion is greater than a threshold value.

20. (canceled)
